(19) United States
(12) Patent Application Publication
(10) Pub. No.: US 2013/0002954 A1
(43) Pub. Date: Jan. 3, 2013

(54) CLOCK GENERATION METHOD AND APPARATUS IN MULTIMEDIA SYSTEM

(76) Inventor: Jong Shin SHIN, Yongin-si (KR)

(21) Appl. No.: 13/451,928

(22) Filed: Apr. 20, 2012

(30) Foreign Application Priority Data
Jun. 29, 2011 (KR) 10-2011-0064071

(51) Int. Cl. H04N 5/06

(52) U.S. Cl. 348/524; 348/E05.011

(57) ABSTRACT

A clock generation method and apparatus in a multimedia system includes generating a first intermediate clock with multiple phases by multiplying a frequency of an input clock by a predetermined factor using a phase-locked loop or a delay-locked loop, generating a transmission clock by dividing a frequency of the first intermediate clock by 5, and generating a pixel clock used in the multimedia system using a frequency of the transmission clock. When the first intermediate clock with the multiple phases is used to generate the pixel clock corresponding to a color depth, the number of phase-locked loops or delay-locked loops necessary for frequency multiplication can be reduced.

### CROSS-REFERENCE TO RELATED APPLICATIONS

This application claims priority under 35 U.S.C. §119 from Korean Patent Application No. 10-2011-0064071 filed on Jun. 29, 2011, the disclosure of which is hereby incorporated by reference in its entirety.

### BACKGROUND

1. Field

The inventive concept relates to a multimedia system, and more particularly, to a clock generation method and apparatus in a multimedia system.

2. Description of the Related Art

High definition multimedia interface (HDMI) has been known as a data interface standard for transmission of digital audio/video signals (or digital content). The HDMI is based on digital video interface (DVI) which is a standard for connecting a personal computer (PC) with a digital display device such as a liquid crystal display (LCD) digitally driven for display and is configured to further include features, such as audio transmission, copyright protection and transmission of color difference. The HDMI is usually used for digital audio/video input/output defined for home appliances and audio visual (AV) equipment. According to the HDMI, a transmitter (or an output device) is referred to as a source and a receiver (or an input device) is referred to as a sink. The transmission of video/audio signal data using HDMI is not two-way but one-way from the source to the sink. However, two-way communication is enabled with respect to a control signal path called a display data channel (DDC).

In HDMI systems, a control signal or a pixel clock is transmitted through a special channel. Control data can be transmitted from a multimedia source to a multimedia sink and also from the multimedia sink to the multimedia source. The multimedia source usually encodes data in 8-bit units and the multimedia sink usually decodes the encoded data in 8-bit units.

Recently, deep color in which a single pixel includes more than 8 bits has been suggested in order to increase color resolution. In other words, it has been suggested that the number of bits (or a color depth) for one color per pixel is 10, 12 or 16.

According to the HDMI, data of a pixel for one color usually includes 8 bits. A synchronous signal such as a horizontal synchronous signal or a vertical synchronous signal is transmitted at proper timing. In addition, a transmission line for a pixel clock for video data and a transmission line for control data are provided.

Data is transmitted between the multimedia source and the multimedia sink, which use HDMI or DVI, using transition minimized differential signaling (TMDS). The TMDS includes a video data period, a data island period, and a control period. Active video data is transmitted in the video data period. Audio information and auxiliary data are transmitted in packets in the data island period. Preamble data is transmitted in the control period.

Usually, the multimedia source includes a phase-locked loop (PLL) generating a pixel clock and generates a transmission clock using a PLL that multiples the pixel clock by 1.25, 1.5 or 2. Accordingly, the multimedia source needs two PLLs, i.e., the pixel clock PLL and the transmission clock PLL. It may also need a jitter-filter PLL to reduce a jitter in the pixel clock occasionally. Therefore, the multimedia source may need a total of 2 to 3 PLLs. When the number of PLLs increases, the area and/or power consumption of the multimedia source also increases. In addition, signal interference is apt to occur between PLLs. Accordingly, it is desired to reduce a circuit area and power consumption by reducing the number of PLLs.

### SUMMARY

The present general inventive concept provides a clock generation method and apparatus and to provide a system having the same.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a clock generation method in a multimedia system. The method includes the operations of generating a first intermediate clock with multiple phases by multiplying a frequency of an input clock by a predetermined factor using a phase-locked loop or a delay-locked loop, generating a transmission clock by dividing a frequency of the first intermediate clock by 5, and generating a pixel clock used in the multimedia system using a frequency of the transmission clock.

The operation of generating the pixel clock may include generating a plurality of second intermediate clocks having a predetermined phase difference from with each other by dividing the first intermediate clock; and generating the pixel clock for a color depth by XOR-gating the second intermediate clocks with each other.

The foregoing and/or other features and utilities of the present general inventive concept may also be achieved by providing a clock generator in a multimedia system. The clock generator includes a transmission clock generator and a pixel clock generator. The transmission clock generator includes a multi-phase unit configured to generate a first intermediate clock with multiple phases by multiplying a frequency of an input clock by a predetermined factor using a phase-locked loop or a delay-locked loop, and a divider configured to generate a transmission clock by dividing a frequency of the first intermediate clock by 5.

The pixel clock generator includes a color depth block configured to generate an output clock from the first intermediate clock according to a 10- or 12-bit color depth and a selector configured to select either the output clock of the color depth block or a pixel clock generated from the transmission clock for an 8-bit or a 16-bit color depth and to output the selected clock as a pixel clock used in the multimedia system.

The color depth block may include a divider configured to generate from the first intermediate clock a plurality of second intermediate clocks sequentially having a predetermined phase difference from each other and an XOR logic unit configured to XOR-gate the second intermediate clocks with each other to generate the pixel clock for a color depth.

The foregoing and/or other features and utilities of the present general inventive concept may be achieved by providing a clock generator usable with a multimedia system. The clock generator may include a transmission clock generator configured to generate a transmission clock and a first intermediate clock with multiple phases from a reference clock using a single phase-locked loop or a single delay-locked loop, and a pixel clock generator configured to generate a plurality of second intermediate clocks using the transmission clock and the first intermediate clock to correspond to a number of color depths, and to select at least one of the generated plurality of pixel clocks according to a selection of the color depths to output the selected one as a pixel clock.

The multimedia system may include a multimedia source including the clock generator and a video processor, and the video processor to process video data according to the pixel clock and to generate the processed video data as parallel data and the pixel clock received from the clock generator.

The multimedia source may include an HDMI transmitter, and the HDMI transmitter may output TDMA data as serial data according the received parallel data and outputs the transmission clock received from the clock generator.

The multimedia system may include a multimedia source and a multimedia sink. The multimedia source may include the clock generator, a video processor to process video data according to the pixel clock, and an HDMI transmitter to output the processed video data as TDMS data and the transmission clock received from the clock generator. The multimedia sink may include an HDMI receiver to receive the TDMS data and the transmission clock, a second clock generator to generate a second pixel clock according to the received transmission clock using a second single phase-locked loop or a second single delay-locked loop, and a second video processor to process the TDMS data according to the second pixel clock of the second clock generator.

The transmission clock generator may include a multi-phase unit having the single phase-locked loop or the single delay-locked loop to receive the reference clock and to generate the transmission clock with a transmission frequency and a divider to divide the transmission clock and to generate the first intermediate clock with a first intermediate frequency higher than the transmission frequency of the transmission clock.

The pixel generator may include a multi-clock generating unit to generate the plurality of second intermediate clocks using the transmission clock and the first intermediate clock, and a selector to select the one of the plurality of second intermediate clocks as the pixel clock.

The multi-clock generating unit may include a plurality of color depth blocks and a plurality of dividers to output the second intermediate clocks.

The multi-clock generating unit may output a first base clock and a second base clock of the plurality of second intermediate clocks using the transmission clock, and may output one or more intermediate clocks of the plurality of second intermediate clocks between the first base clock and the second base clock using the first intermediate clock.

The multi-clock generating unit may include one or more color depth clocks to output one or more color depth bit clocks using the first intermediate clock and one or more divider to divide the corresponding color depth bit clocks to generate the plurality of intermediate clocks of the plurality of second intermediate clocks.

The first intermediate clock may have a first number of multiple phases, and the second intermediate clocks may have different numbers of multiple phases.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a diagram illustrating a multimedia source including a clock generator according to an embodiment of the inventive concept;

FIG. 2 is a diagram illustrating the clock generator of the FIG. 1 according to an embodiment of the inventive concept;

FIG. 3 is a signal diagram illustrating a first intermediate clock with multiple phases and a clock having a ⅘ frequency of the first intermediate clock according to an embodiment of the inventive concept;

FIG. 4A is a timing chart illustrating an operation of generating a pixel clock when a color depth is 10 bits according to an embodiment of the inventive concept;

FIG. 4B is a circuit diagram illustrating a 10-bit color depth block of the clock generator of FIG. 2;

FIG. 5A is a timing chart illustrating an operation of generating a pixel clock when a color depth is 12 bits according to an embodiment of the inventive concept;

FIG. 5B is a circuit diagram illustrating a 12-bit color depth block of the clock generator of FIG. 2;

FIG. 6 is a diagram illustrating the clock generator of FIG. 1 according to an embodiment of the inventive concept;

FIG. 7 is a diagram illustrating a system including a multimedia source and a multimedia sink according to an embodiment of the inventive concept;

FIG. 8A is a diagram illustrating the multimedia source of the system of FIG. 7 according to an embodiment of the inventive concept;

FIG. 8B is a diagram illustrating the multimedia sink of the system of FIG. 7 according to an embodiment of the inventive concept;

FIG. 9 is a diagram illustrating a clock generator included in the multimedia sink of FIG. 8B according to an embodiment of the inventive concept;

FIG. 10A is a flowchart illustrating a clock generation method according to an embodiment of the inventive concept;

FIG. 10B is a flowchart illustrating a method of generating an output clock of a 10-bit color depth block according to an embodiment of the inventive concept;

FIG. 10C is a flowchart illustrating a method of generating an output clock of a 12-bit color depth block according to an embodiment of the inventive concept; and

FIG. 11 is a flowchart illustrating a clock generation method in a multimedia sink according to an embodiment of the inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

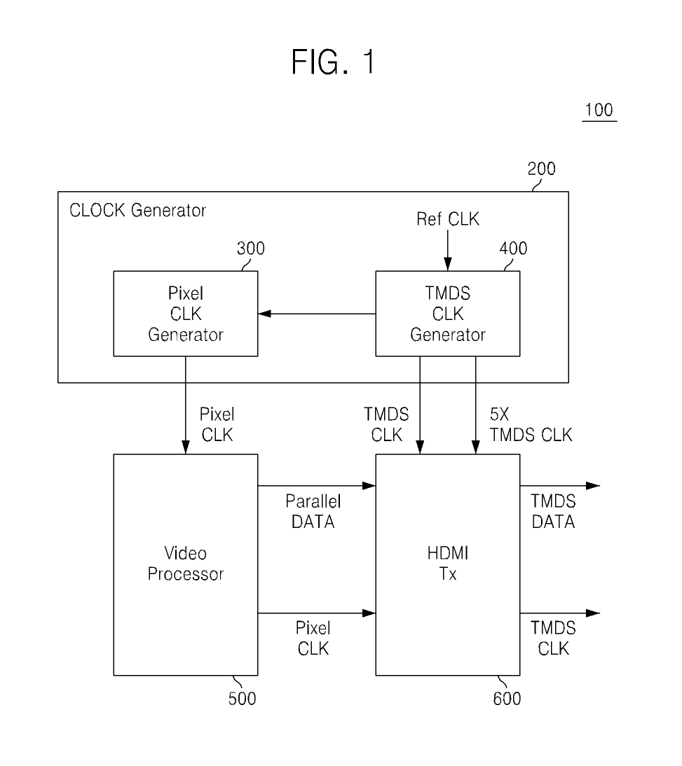

FIG. 1 is a diagram illustrating a multimedia source 100 including a clock generator 200 according to an exemplary embodiment of the inventive concept. The multimedia source 100 includes the clock generator 200, a video processor 500, and a high definition multimedia interface transmitter (HDMI Tx) 600. The clock generator 200 includes a transmission clock generator or a transition minimized differential signaling (TMDS) clock generator 400 generating a transmission clock TMDS CLK using a reference clock Ref CLK and a pixel clock generator 300 generating a pixel clock PIXEL CLK. The multimedia source 100 may be a DVD player, a set-top box or a television (TV) but is not restricted thereto.

Although the HDMI Tx 600 is illustrated in FIG. 1 as an example of a transmitter of the multimedia source 100, the inventive concept is not restricted thereto. The inventive concept can be applied to any transmitter in which a difference between a frequency of the reference clock Ref CLK input to the TDMS CLK generator 400 and a frequency of the transmission clock TMDS CLK output from the TDMS CLK generator 400 or the HDMI Tx 600 is at least 1 time higher than the frequency of the reference clock Ref CLK. In other words, the frequency of the transmission clock TMDS CLK output from the HDMI Tx 600 is at least 1 time higher than the frequency of the pixel clock PIXEL CLK input to the HDMI Tx 600.

The video processor 500 controls an overall operation of processing and externally transmitting video data. The video processor 500 outputs parallel data in synchronization with the pixel clock PIXEL CLK. In other words, the pixel clock PIXEL CLK and the parallel data have the same period. The parallel data includes color component data, for example, R pixel data, G pixel data and B pixel data. The parallel data may include control data and/or information data to control the color component data or provide information on the color component data. The video processor 500 compresses video data to be transmitted using Moving Picture Experts Group (MPEG) or Joint Photographic Experts Group (JPEG) methodology. The video processor 500 receives the pixel clock PIXEL CLK from the pixel clock generator 300 of the clock generator 200. The pixel clock PIXEL CLK is used as a digital clock of a link logic (not shown) or the video processor 500. The video processor 500 may receive the video data and process the received video data. It is possible that the video processor 500 may have a storage unit to store the video data. The video processor 500 processes the video data to generate the parallel data according to the pixel clock PIXEL CLK. The video processor 500 may have an interface unit to receive the video data, a storage unit to store the received video data to process the video data, a processing unit to process the video data to generate the parallel data, and a control unit to control an operation of the interface unit, the storage unit, and the processing unit.

The HDMI Tx 600 latches the parallel data at rising and falling edges of a transmission clock-multiplied-by-5 (referred to as a 5× transmission clock) 5× TMDS CLK to generate serial data TMDS DATA. The HDMI Tx 600 outputs the serial data TMDS DATA and the transmission clock TMDS CLK. Here, the 5× transmission clock 5× TMDS CLK and the transmission clock TMDS CLK are generated by the transmission clock generator 400 of the clock generator 200 and input to the HDMI Tx 600. A period of the transmission clock TMDS CLK is 10 times faster than that of the serial data TMDS DATA. Although not illustrated, the transmission clock TMDS CLK and the serial data TMDS DATA may be transmitted as differential signals.

The clock generator 200 includes the transmission clock generator 400 and the pixel clock generator 300. The transmission clock generator 400 multiplies the reference clock Ref CLK using a phase-locked loop (PLL) or a delay-locked loop (DLL) to generate the transmission clock TMDS CLK. The pixel clock generator 300 multiplies or divides the transmission clock TMDS CLK generated by the transmission clock generator 400.

In the current embodiment of the inventive concept, the multimedia source 100 uses a single PLL or DLL in order to support a deep color of a pixel of an image as color component data. The multimedia source 100 generates the transmission clock TMDS CLK and generates the pixel clock PIXEL CLK from the transmission clock TMDS CLK. The pixel clock PIXEL CLK is generated by multiplying or dividing the transmission clock TMDS CLK. Since the multimedia source 100 uses a single PLL to generate the transmission clock TMDS CLK, the number of PLLs decreases.

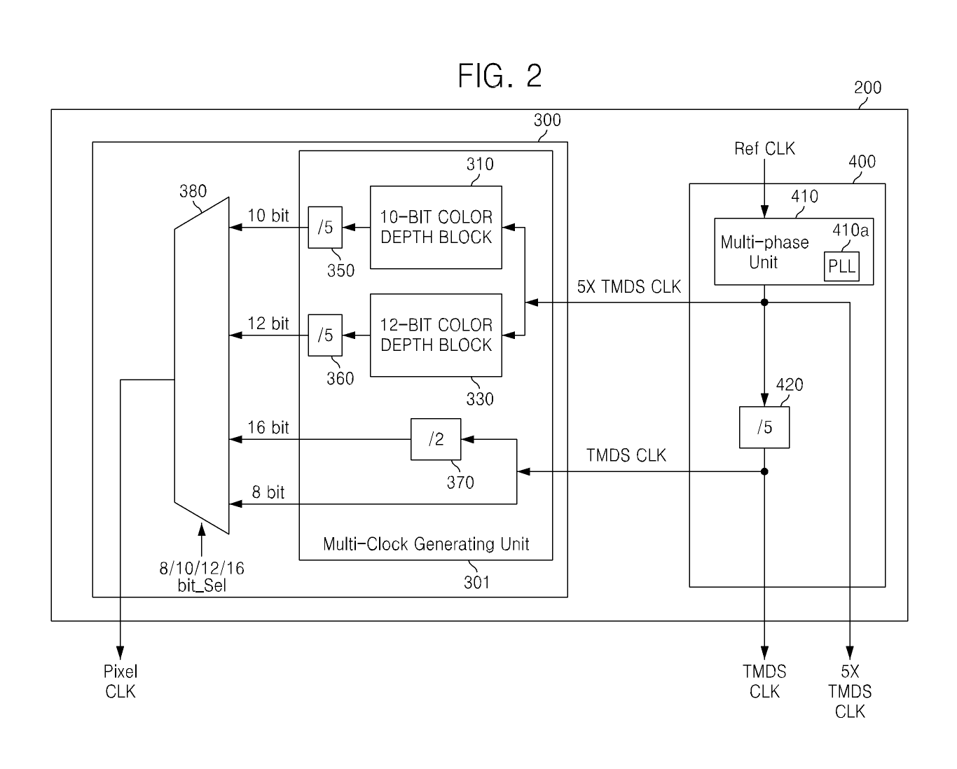

FIG. 2 is a diagram illustrating the clock generator 200 of FIG. 1 according to an embodiment of the inventive concept. The clock generator 200 includes the transmission clock generator 400 and the pixel clock generator 300. The transmission clock generator 400 includes a multi-phase unit 410 and a divider 420.

The multi-phase unit 410 receives the reference clock Ref CLK and generates the 5× transmission clock 5× TMDS CLK. The 5× transmission clock 5× TMDS CLK is a clock with a frequency 5 times the frequency of the transmission clock TMDS CLK and is used to convert the parallel data into the serial data TMDS DATA. The divider 420 divides the frequency of the 5× transmission clock 5× TMDS CLK by 5 to generate the transmission clock TMDS CLK. The 5× transmission clock 5× TMDS CLK is referred to as a first intermediate clock. In the current embodiments, the reference clock Ref CLK may be obtained using an embedded high-precision liquid crystal oscillator (not shown), but the inventive concept is not restricted to the current embodiments.

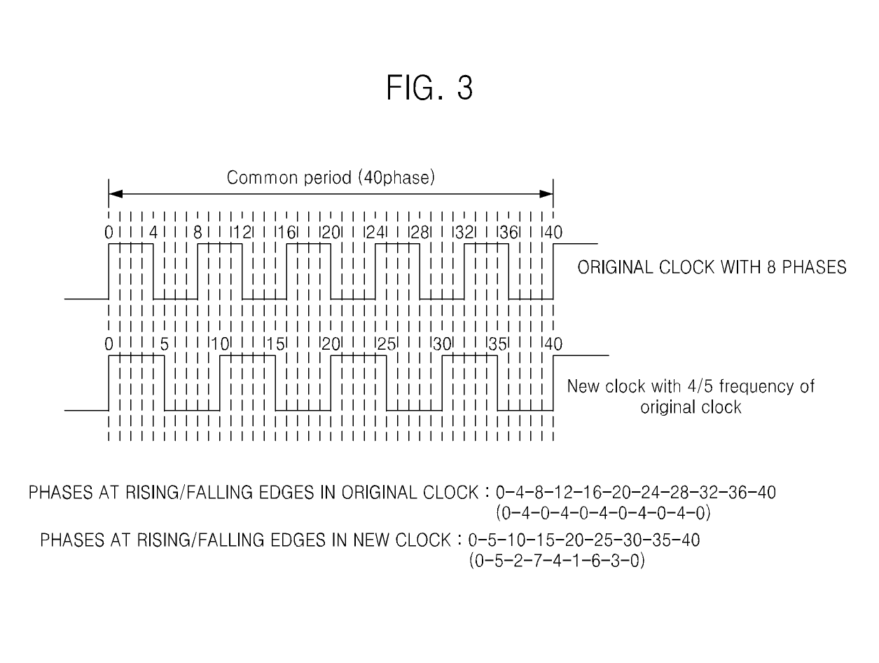

The multi-phase unit 410 is a clock multiplication unit and may use a PLL or a DLL 410a. When the multi-phase unit 410 uses the PLL 410a, it may detect a phase/frequency difference between an input clock and a divided clock (i.e., a clock obtained by dividing a frequency of an output clock by, for example, a natural number N) using a phase frequency detector (not illustrated) and may adjust the frequency of the output clock based on a detection result. When the multi-phase unit 410 uses the DLL 410a, it may detect a phase/frequency difference between an input clock and an output clock using a phase frequency detector (not illustrated) and may adjust a delay between a plurality of delay cells included in a delay line based on a detection result. At this time, in order to differentiate multiple phases in the pixel clock generator 300, the multi-phase unit 410 multiples the frequency of the reference clock Ref CLK and also uses the multi-phase of a voltage controlled oscillator (VCO) clock within the PLL 410a when generating the 5× transmission clock 5× TMDS CLK, i.e., the first intermediate clock. The multi-phase will be described later with reference to FIG. 3.

The pixel clock generator 300 generates a plurality of pixel clocks from the transmission clock TMDS CLK and the first intermediate clock 5× TMDS CLK and selects the pixel clock PIXEL CLK from among the plurality of pixel clocks according to a color depth. The color depth is the number of bits used to represent (or store) color information of a pixel of an image. That is, the number of bits assigned to a color may be variable according to a depth (level) of the color. For instance, that the color depth of a G pixel is 10 bits means that 10 bits are used to store color information of the G pixel. According to HDMI supporting deep color, a difference between the frequency of the pixel clock PIXEL CLK and the frequency of the transmission clock TMDS CLK may be 1, 1.25, 1.5 or 2 times the frequency of the pixel clock PIXEL CLK according to the color depth.

The pixel clock generator 300 includes a 10-bit color depth block 310, a 12-bit color depth block 330, dividers 350, 360 and 370, and a selector 380.

The color depth changes depending on the frequency ratio between the transmission clock TMDS CLK and the pixel clock PIXEL CLK. For instance, when the color depth is 8 bits, the frequency ratio is 1:1. When the color depth is 10 bits, the frequency ratio is 5:4. When the color depth is 12 bits, the frequency ratio is 3:2. When the color depth is 16 bits, the frequency ratio is 2:1. Accordingly, 8-, 10-, 12- and 16-bit pixel clocks PIXEL CLK respectively have frequencies 1, ⅘, ⅔ and ½ times, respectively, the frequency of the transmission clock TMDS CLK.

The pixel clock PIXEL CLK with a color depth of 16 bits may be generated by using only a ½ divider 370 without multiplying the frequency of the transmission clock TMDS CLK. The pixel clock PIXEL CLK with a color depth of 8 bits may be generated directly from the transmission clock TMDS CLK. The ½ divider 370 may be embodied without using a PLL or a DLL. That is, the pixel clock generator 300 may not have a PLL or a DLL.

For the -10-bit color depth, the frequency of the pixel clock PIXEL CLK needs to be ⅘ times the frequency of the transmission clock TMDS CLK. Accordingly, the frequency of the transmission clock TMDS CLK needs to be divided by 5 and then multiplied by 4. A multiplier is needed for the multiplication by 4. Similarly, for the 12-bit color depth, the frequency of the pixel clock PIXEL CLK needs to be ⅔ times the frequency of the transmission clock TMDS CLK. Accordingly, the frequency of the transmission clock TMDS CLK needs to be divided by 3 and then multiplied by 2. A multiplier is also needed for the multiplication by 2.

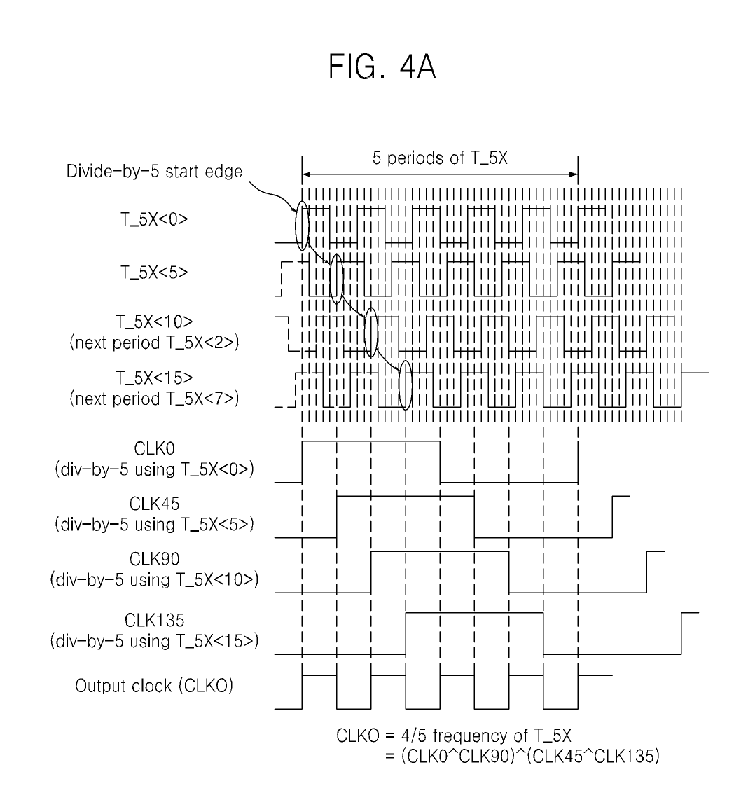

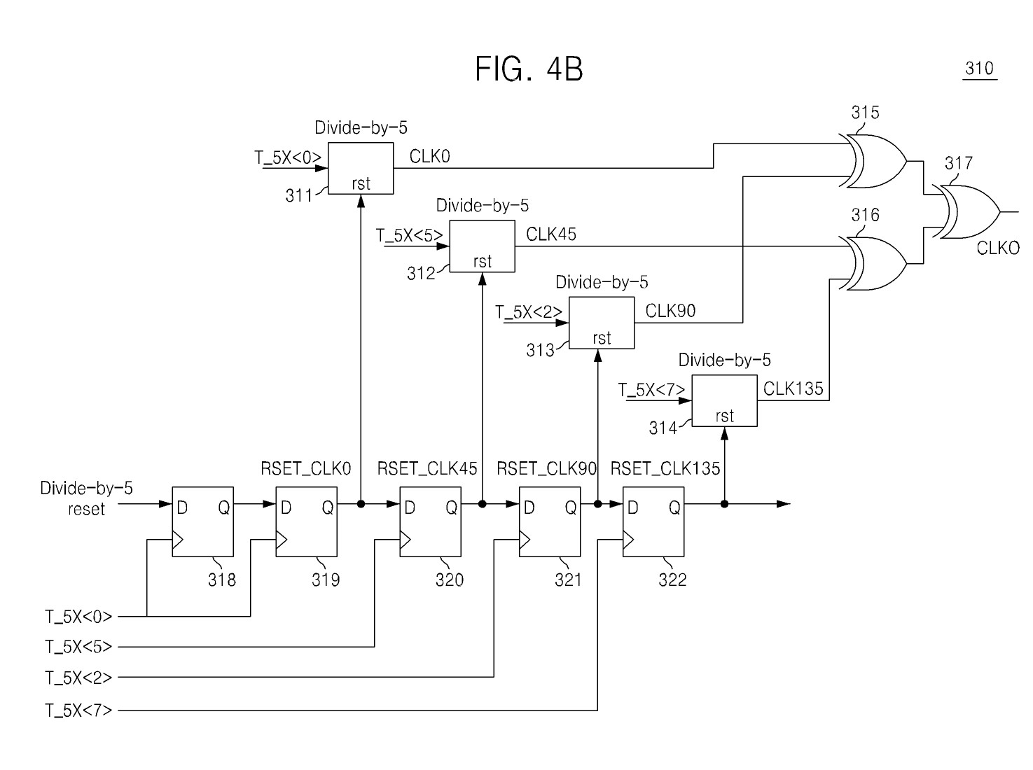

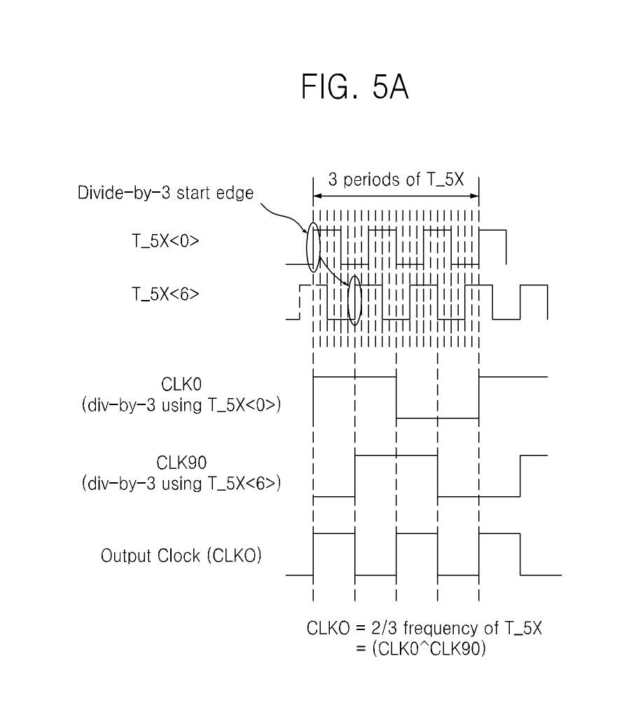

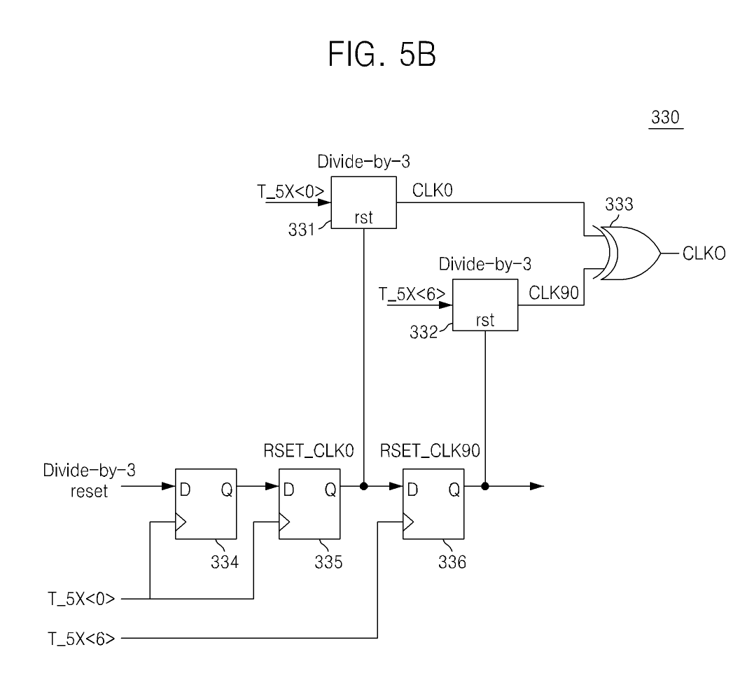

For the multiplication of a frequency, a feedback-based circuit such as a PLL or a frequency multiplying DLL is usually used. However, in the embodiments of the inventive concept, the 10-bit color depth block 310 and the 12-bit color depth block 330, which use the first intermediate clock 5× TMDS CLK as a feedforward input, are used to reduce the number of necessary PLLs or DLLs. A signal output from the color depth block 310 or 320 having the first intermediate clock 5× TMDS CLK as an input is processed by the divider 350 or 360 to be output as the pixel clock PIXEL CLK. The color depth blocks 310 and 320 will be described later with reference to FIGS. 4A through 5B.

The pixel clock generator 300 also includes the first divider 350 and the second divider 360, which divide the frequency of the first intermediate clock 5× TMDS CLK by 5 since the frequency of the first intermediate clock 5× TMDS CLK is 5 times the frequency of the transmission clock TMDS CLK, and the selector 380 which selects the pixel clock PIXEL CLK corresponding to a color depth needed or required in the multimedia source 100 or determined or set by a user through a user input unit of the video processor 500 of the multimedia source 100. The selector 380 may be controlled by a control signal 8/10/12/16-bit_Sel to select the pixel clock PIXEL CLK corresponding to the color depth and may be implemented by a multiplexer. The clock generator 200 is configured to select the pixel clock PIXEL CLK according to the color depth of the multimedia source 100, but the inventive concept is not limited thereto. The clock generator 200 may be configured to automatically determine the pixel clock PIXEL CLK. The pixel clock PIXEL CLK may be variable according to the color depths of the pixels. The pixel clock generator 300 may generate a plurality of pixel clocks and select at least one of the plurality of pixel clocks as the pixel clock PIXEL CLK to be usable in the video processor 500.

The 10-bit color depth block 310, the 12-bit color depth block 330, and the dividers 350, 360 and 370 may be referred to as a multi-clock generating unit 301 to generate a plurality of second intermediate clocks (pixel clocks). The multi-clock generating unit 301 may output the 8-bit clock and the 16-bit clock as a first base clock and a second base clock using the transmission clock, and also output the 10-bit clock and the 12-bit clock as intermediate clocks using the first intermediate clock.

FIG. 3 is a signal diagram illustrating a first intermediate clock with multiple phases and a clock having a ⅘ frequency of the first intermediate clock according to an embodiment of the inventive concept. FIG. 4A is a timing chart illustrating a method of generating a pixel clock when a color depth is 10 bits according to an embodiment of the inventive concept. When the color depth is 10 bits and a first intermediate clock T_{—}5× (i.e., 5× TMDS CLK) input to the pixel clock generator 300 has 8 phases, a clock with ⅘ frequency of the first intermediate clock T_{—}5× is generated. Since there are 8 phases in a single period of the first intermediate clock T_{—}5×, 40 phases exist in 5 periods of the first intermediate clock T_{—}5×. If a new clock with 10 phases in a single period is generated, the new clock has ⅘ frequency of the first intermediate clock T_{—}5×, i.e., an original clock as illustrated in FIG. 3. In other words, when the rising/falling edges of the first intermediate clock 5× TMDS CLK, i.e., the original clock occur at phases 0, 4, 8, 12, 16, 20, 24, 28, 32, 36 and 40 in order, the new clock with ⅘ frequency of the original clock has the rising/falling edges at phases 0, 5, 10, 15, 20, 25, 30, 35 and 40 in order. Here, the phases may include, for example, a phage corresponding to 0 degree, and phases corresponding to respective degrees, for example, 45, 90, 135, 180, 225, 270, and 315 degrees, respectively, with respect to 0 degree. It is possible that the phases may repeat degrees of 0, 45, 90, 135, and 180, and then degrees of −45 corresponding to 225 degrees, −90 corresponding to 270 degrees, −135 corresponding to 315 degrees, and −180 corresponding to 360 degrees.

Referring to FIG. 4A, for the 10-bit color depth, four second intermediate clocks CLK0, CLK45, CLK90 and CLK135 are generated by dividing the frequency of the first intermediate clock T_{—}5× by 5 using the four phases <0>, <5>, <2>and <7> (i.e., <0> corresponding to a phase of 0 degree, <5> corresponding to a phase of 225 degrees which may correspond to 45 degrees, <10> corresponding to 450 degrees which may be 90 degrees, and <15> corresponding to 675 degrees which may be 315 degrees) of the first intermediate clock T_{—}5×. Since the second intermediate clocks CLKO, CLK45, CLK90 and CLK135 have a 45-degree phase difference from each other, the frequency of an output clock CLKO resulting from XOR-gating the second intermediate clocks CLK0, CLK45, CLK90 and CLK135 with one another is ⅘ of the frequency of the first intermediate clock T_{—}5×. At this time, the second intermediate clocks CLK0 and CLK90 are XOR-gated with each other and the second intermediate clocks CLK45 and CLK135 are exclusive OR-gated (XOR-gated) with each other and then two results of the XOR-gating are XOR-gated with each other.

Accordingly, the output clock CLKO may be expressed as “CLKO=⅘ frequency of T_{—}5×=(CLK0̂CLK90)̂(CLK45̂CLK135)” where “̂” denotes an exclusive OR-gating (XOR-gating).

FIG. 4B is a circuit diagram illustrating the 10-bit color depth block 310 of FIG. 2. Referring to FIGS. 1 through 4B, the 10-bit color depth block 310 includes a first divider 311 to receive and divide a first intermediate clock with a phase of 0degrees (referred to as a 0-degree first intermediate clock T_{—}5×<0>) by 5, a second divider 312 to receive and divide a first intermediate clock with a phase of 45 degrees (referred to as a 45-degree first intermediate clock T_{—}5×<5>) by 5, a third divider 313 to receive and divide a first intermediate clock with a phase of 90 degrees (referred to as a 90-degree first intermediate clock T_{—}5×<2>) by 5, a fourth divider 314 to receive and divide a first intermediate clock with a phase of 135 degrees (referred to as a 135-degree first intermediate clock T_{—}5×<7>) by 5, a first logic gate 315 to perform the XOR-gating the second intermediate clock CLKO output from the first divider 311 with the second intermediate clock CLK90 output from the third divider 313, a second logic gate 316 to perform the XOR-gating the second intermediate clock CLK45 output from the second divider 312 with the second intermediate clock CLK135 output from the fourth divider 314, and a third logic gate 317 to perform the XOR-gating an output from the first logic gate 315 with an output of the second logic gate 316.

The 10-bit color depth block 310 may also include flip-flops 318 through 322 to respectively synchronize the dividers 311 through 314 with corresponding one of the multiple phases of the first intermediate clock T_{—}5× so that the start points of the dividers 311 through 314 are regular and the phase differences among the second intermediate clocks CLK0, CLK45, CLK90 and CLK135 are regular.

A reset signal RSET_CLK0 input to the first divider 311 is an output of the second flip-flop 319, which receives the 0-degree first intermediate clock T_{—}5×<0> and an output of the first flip-flop 318 receiving a divide-by-5 control signal and the 0-degree first intermediate clock T_{—}5×<0>. At this time, the first flip-flop 318 is provided to more accurately control the phase differences. A reset signal RSET_CLK45 input to the second divider 312 is an output of the third flip-flop 320 which receives the 45-degree first intermediate clock T_{—}5×<5> and an output of the second flip-flop 319. A reset signal RSET_CLK90 input to the third divider 313 is an output of the fourth flip-flop 321 which receives the 90-degree first intermediate clock T_{—}5×<2> and an output of the third flip-flop 320. A reset signal RSET_CLK135 input to the fourth divider 314 is an output of the fifth flip-flop 322 which receives the 135-degree first intermediate clock T_{—}5×<7> and an output of the third flip-flop 321. In other words, the first through fifth flip-flops 318 through 322 are provided to generate reset signals for synchronizing the start points of the dividers 311 through 314 with the phases of the first intermediate clock T_{—}5×, respectively, so that the four second intermediate clocks CLK0, CLK45, CLK90 and CLK135 having a 45-degree phase difference between adjacent clocks are generated after the frequency of the first intermediate clock T_{—}5× is divided by 5.

FIG. 5A is a timing chart illustrating an operation of generating a pixel clock when a color depth is 12 bits according to some embodiments of the inventive concept. Similarly to the case of the 10-bit color depth, for the 12-bit color depth, two second intermediate clocks CLK0 and CLK90 are generated by dividing the frequency of the first intermediate clock T_{—}5× by 3 using phases of the first intermediate clock T_{—}5× in order. Since the second intermediate clocks CLKO and CLK90 have a 90-degree phase difference from each other, the frequency of an output clock CLKO resulting from XOR-gating the second intermediate clocks CLK0 and CLK90 with each other is ⅔ of the frequency of the first intermediate clock T_{—}5×.

Accordingly, the output clock CLKO may be expressed as “CLKO=⅔ frequency of T_{—}5×=(CLK0̂CLK90)” where “̂” denotes XOR-gating.

FIG. 5B is a circuit diagram illustrating the 12-bit color depth block 330 of FIG. 2. Referring to FIGS. 1 through 3 and FIGS. 5A and 5B, the 12-bit color depth block 330 includes a first divider 331 which receives and divides a 0-degree first intermediate clock T_{—}5×<0> by 3, a second divider 332 which receives and divides a 90-degree first intermediate clock T_{—}5×<6>, by 3, and a first logic gate 333 which XOR-gates the second intermediate clock CLK0 output from the first divider 331 with the second intermediate clock CLK90 output from the second divider 332.

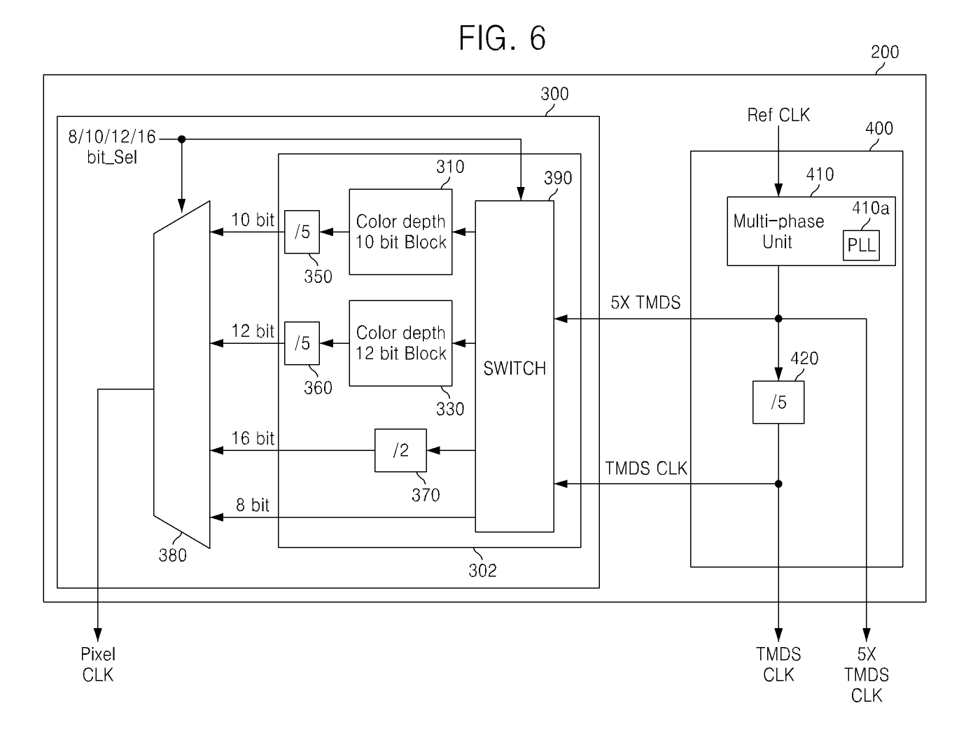

FIG. 6 is a diagram illustrating the clock generator 200 of FIG. 1 according to an embodiment of the inventive concept. Referring to FIG. 6, as is described with reference to

FIG. 2, the clock generator 200 includes the transmission clock generator 400 and the pixel clock generator 300 and outputs a transmission clock TMDS CLK, a first intermediate clock 5× TMDS CLK, and a pixel clock PIXEL CLK. The transmission clock generator 400 includes the multi-phase unit 410 and the divider 420. As compared to the pixel clock generator 300 illustrated in FIG. 2, the pixel clock generator 300 illustrated in FIG. 6 may further include a switch unit 390 which receives the first intermediate clock 5× TMDS CLK and the transmission clock TMDS CLK and selectively outputs either of the first intermediate clock 5× TMDS CLK and the transmission clock TMDS CLK in response to a control signal bit_Sel. The control signal bit_Sel may be output from the video processor 500 of FIG. 1. When the switch unit 390 is provided, power consumption is decreased furthermore.

The 10-bit color depth block 310, the 12-bit color depth block 330, the dividers 350, 360 and 370 and the switch 390 may be referred to as a multi-clock generating unit 302 to generate a plurality of second intermediate clocks (pixel clocks). The multi-clock generating unit 302 may output the 8-bit clock and the 16-bit clock as a first base clock and a second base clock using the transmission clock, and also output the 10-bit clock and the 12-bit clock as intermediate clocks using the first intermediate clock.

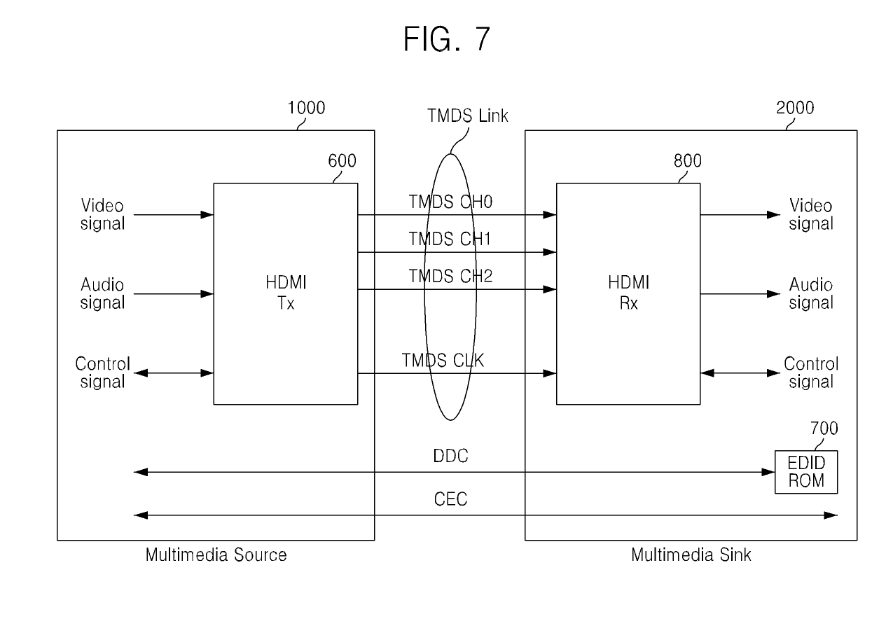

FIG. 7 is a diagram illustrating a system including a multimedia source 1000 and a multimedia sink 2000 according to an embodiment of the inventive concept. Referring to FIG. 7, the system includes the multimedia source 1000 and the multimedia sink 2000 to output a multimedia signal. The multimedia source 1000 of FIG. 7 may have the same structure and operation as the multimedia source 100 illustrated in FIG. 1. The multimedia source 1000 includes a transmitter, i.e., the HDMI Tx 600 which converts parallel data, i.e., a video signal and an audio signal, into high-speed serial data TMDS CH0, TMDS CH1 and TMDS CH2.

The video processor 500 of FIG. 1 may have another processing unit to receive and process the audio signal such that the HDMI Tx 600 can covert parallel data of the video signal and the audio signal into the high-speed serial data. The multimedia source 100 of FIG. 1 may have a storage unit to store the video signal and the audio signal. The storage unit may be detachably attached to the multimedia source 100 of FIG. 1.

The multimedia source 1000 may generate channel signals TMDS CH0, TMDS CH1, and TMDS CH2, and a clock signal TMDS CLK and transmit the channel signals and clock signal to the multimedia sink 2000 through a TMDS link.

The multimedia source 1000 may also transmit signals, for example, data display channel (DDC) signal and consumer electronic control (CEC) signal to the multimedia sink 2000. The signal DDC may correspond to data stored in an extended display identification data ROM (EDID ROM) 700 and may be usable to identify and adjust characteristics of a source of the video signal and a source of a display device to display an image corresponding to the video signal. According to the identification of the source, the system may perform the processing of the respective data and the transmission between the multimedia source 1000 and the multimedia sink 2000 also with the display device such that an image can be properly displayed on the display device. The signal CEC may allow HDMI devices, for example, the multimedia source 1000 and the multimedia sink 2000, to control each other when necessary. The signal CEC may allow a user to operate multiple devices, for example, the multimedia source 1000 and the multimedia sink 2000 with a display device, with one remote control handset. Since the DDC and CEC are well known, detail descriptions thereof will be omitted.

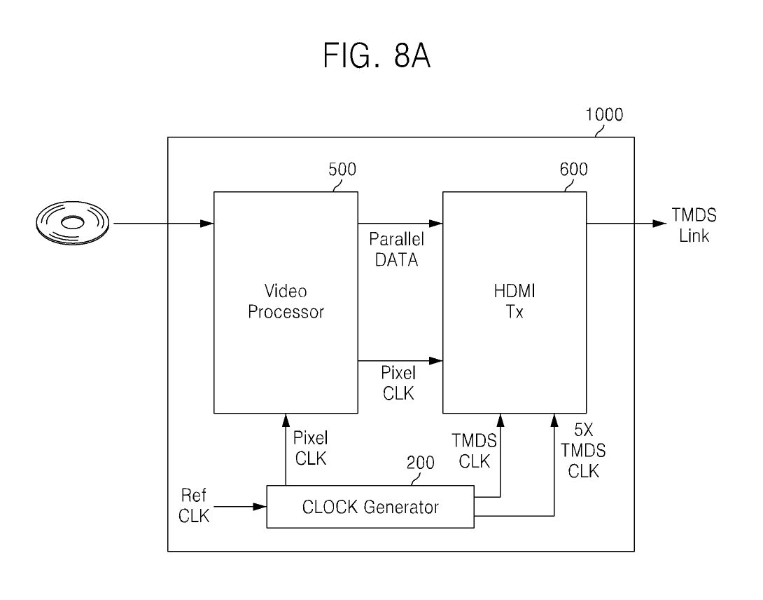

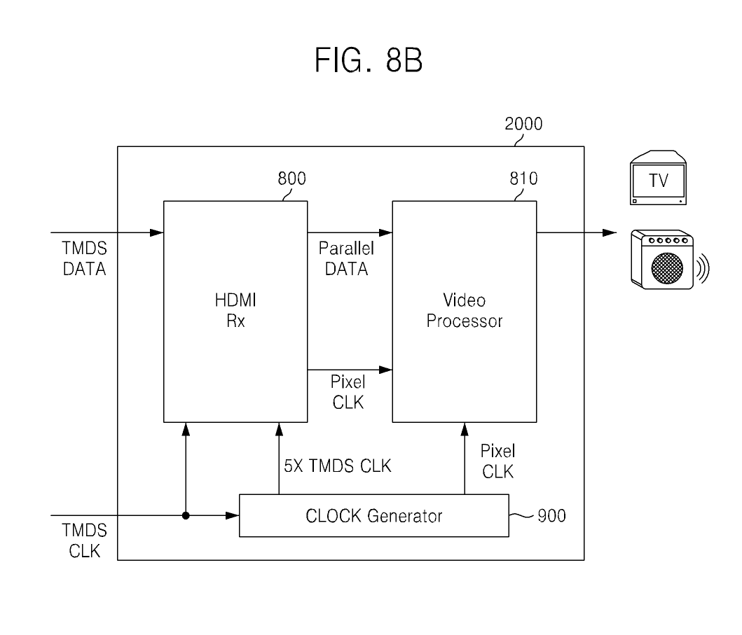

FIG. 8A is a diagram illustrating the multimedia source 1000 of the system of FIG. 7 according to an embodiment of the inventive concept. FIG. 8B is a diagram illustrating the multimedia sink 2000 of the system of FIG. 7 according to an embodiment of the inventive concept.

Referring to FIGS. 8A and 8B, the multimedia sink 2000 includes a receiver, i.e., an HDMI Rx 800 which receives high-speed serial data transmitted from the multimedia source 1000. The multimedia sink 2000 also includes a device (not illustrated) which converts serial video data into parallel data, for example, a video signal, an audio signal, and a control signal. The multimedia sink 2000 may be a TV, a personal digital assistant (PDA), a portable phone, a navigator, a mobile device, etc. the multimedia sink 2000 may have a display device installed thereon, detachably attached to the multimedia sink 2000, or an external display device connectable to the multimedia sink 2000 through a signal cable.

The multimedia source 1000 and the multimedia sink 2000 are connected with each other via a TMDS link for high-speed data transmission. The TMDS link has the following features.

Firstly, video data is encoded and then transmitted as encoded words. Each 8-bit word of digital video data is converted to an encoded 10-bit word before transmission. Here, the encoding includes determining a set of “in-band” words and a set of “out-of-band” words. An encoder can generate only “in-band” words in response to video data, although it can generate “out-of-band” words in response to control or synchronous signals. Each in-band word is an encoded word resulting from the encoding of one input video data word. All words transmitted over the link except for in-band words are “out-of-band” words. In addition, the encoding of video data is performed such that the in-band words are transition-minimized.

A sequence of in-band words has a reduced or minimized number of transitions. The encoding of video data is performed such that the in-band words are DC-balanced. In other words, the encoding prevents each transmitted voltage waveform that is used to transmit a sequence of in-band words from deviating by more than a predetermined threshold value from a reference voltage. The tenth bit of an “in-band” word indicates whether eight of the other nine bits thereof have been inverted during the encoding process to correct an imbalance between numbers of ones and zeroes in the stream of previously encoded data bits.

Secondly, the encoded video data and a video clock signal are transmitted as differential signals. In other words, the video clock signal and the encoded video data are transmitted as differential signals over conductor pairs.

Thirdly, three conductor pairs are usable to transmit the encoded video signal, and a fourth conductor pair is usable to transmit the video clock signal. Fourthly, signal transmission occurs in one direction from the transmitter 600 to the receiver 800.

The multimedia source 1000 and the multimedia sink 2000 both use HDMI. The HDMI is a format which integrates video signals and audio signals into a single digital interface and is usable with audio visual (AV) equipment, such as a DVD player, an HDTV and a set-top box. The HDMI adopts high-bandwidth digital content protection (HDCP) and is based on digital video interface (DVI). The HDCP is copyright protection technology set by INTEL Corporation for baseband systems and requires mutual authorization between devices like digital transmission content protection (DTCP). The HDMI supports standard, extended or HD video signals and standard-multichannel audio signals as well. The HDMI enables non-compressed digital video signals to be transmitted at a maximum rate of 5 GB per second from the multimedia source 1000 to the multimedia sink 2000 using a single port.

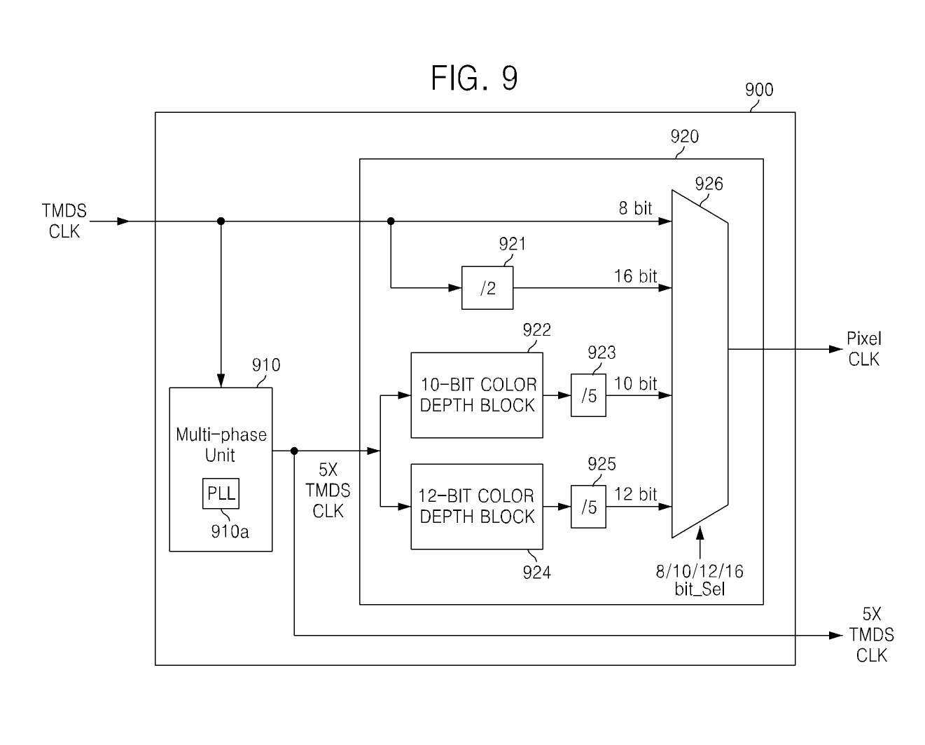

FIG. 9 is a diagram illustrating a clock generator 900 included in the multimedia sink 2000 of FIG. 8B, according to an embodiment of the inventive concept. Although the clock generator 200 of FIG. 1 has the reference clock Ref CLK as an input signal in the multimedia source 1000, the clock generator 900 has the transmission clock TMDS CLK in the TMDS link as an input signal. The clock generator 900 includes a multi-phase unit 910 which receives the transmission clock TMDS CLK and multiplies the frequency of the transmission clock TMDS CLK to generate the first intermediate clock 5× TMDS CLK with multiple phases and a pixel clock generator 920 which receives the first intermediate clock 5× TMDS CLK and the transmission clock TMDS CLK and outputs the pixel clock PIXEL CLK. The multi-phase unit 910 may have a single PLL or DLL.

The pixel clock generator 920 may include a first divider 921 to receive the transmission clock TMDS CLK and to generate a pixel clock for a 16-bit color depth, a 10-bit color depth block 922 and a second divider 923 to generate a pixel clock for a 10-bit color depth from the first intermediate clock 5× TMDS CLK, a 12-bit color depth block 924 and a third divider 925 to generate a pixel clock for a 12-bit color depth from the first intermediate clock 5× TMDS CLK, and a selector 926 to output the pixel clock PIXEL CLK corresponding to a currently required or determined color depth. The output of the pixel clock PIXEL CLK corresponding to the required or determined color depth is controlled by a control signal 8/10/12/16-bit_Sel. The selector 926 may be implemented by a multiplexer. The control signal 8/10/12/16-bit_Sel may be generated from the video processor 8 or the HDMI Rx according to the received TDMS data. The selector 926 may receive a plurality of bit clocks, such as the 8 bit clock, the 10 bit clock, the 12 bit clock, and 16 bit clock, and may selectively select at least one of the plurality of bit clocks as the pixel clock PIXEL CLK.

The clock generator 900 illustrated in FIG. 9 is configured to select the pixel clock PIXEL CLK according to the color depth of the multimedia sink 2000, but the configuration of the clock generator 900 is not restricted to the current embodiments in the inventive concept. The pixel clock generator 920 may also include a switch unit to allow only the required or determined pixel clock PIXEL CLK to be generated.

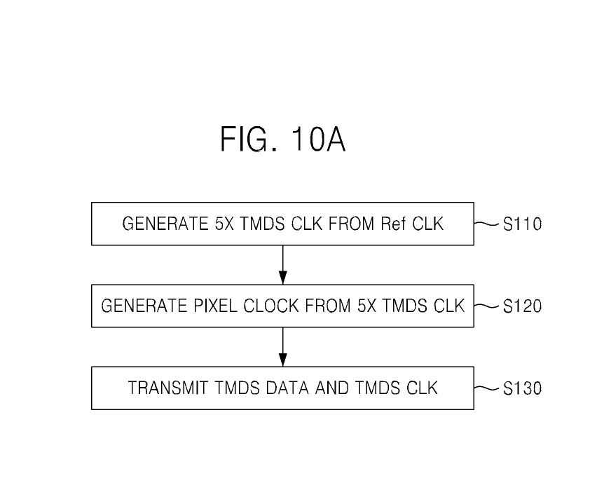

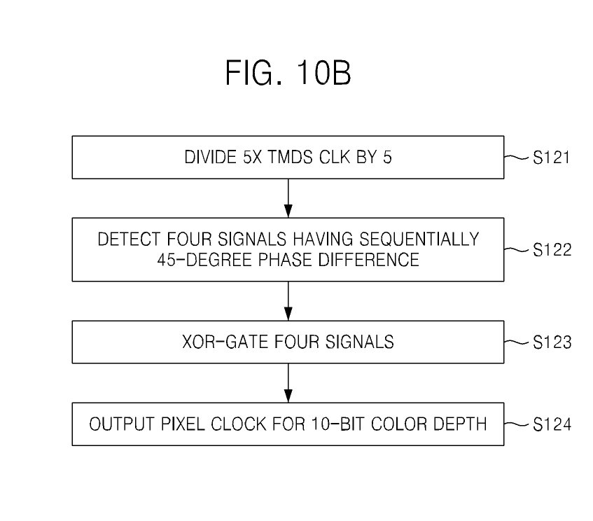

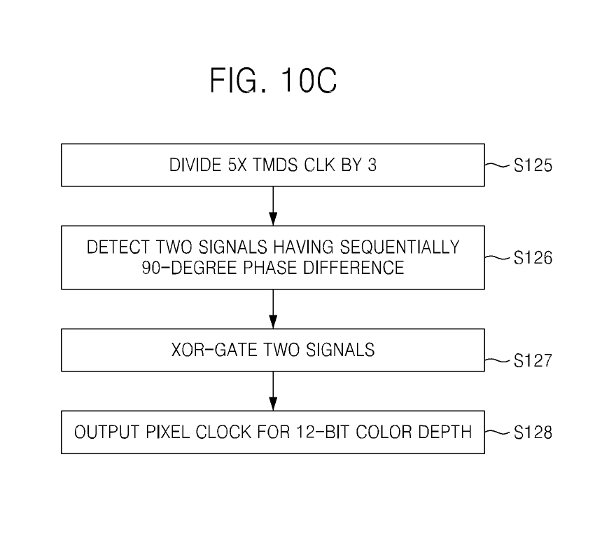

FIG. 10A is a flowchart illustrating a clock generation method according to an embodiment of the inventive concept.

Referring to FIG. 10A, a multimedia source generates a first intermediate clock 5× TMDS CLK from an input signal (e.g., a reference signal Ref CLK) using a PLL or a DLL in operation S110. A pixel clock PIXEL CLK corresponding to a color depth of an image of a video signal is generated from the first intermediate clock 5× TMDS CLK and a transmission clock TMDS CLK in operation S120. A transmitter of the multimedia source transmits TMDS data and the transmission clock TMDS CLK to a multimedia sink via a TMDS link in operation S130.

FIG. 10B is a flowchart illustrating a method of generating an output clock of a 10-bit color depth block according to an embodiment of the inventive concept. Referring to FIG. 10B, the 10-bit color depth block receives a first intermediate clock 5× TMDS CLK and divides the frequency of the first intermediate clock 5× TMDS CLK by 5 in operation S121 and detects four second intermediate clocks CLK0, CLK45, CLK90 and CLK135 having sequentially a 45-degree phase difference using first through fourth dividers in operation S122. At this time, flip-flops may be used to synchronize the phase difference with the first intermediate clock 5× TMDS CLK. The second intermediate clocks CLK0 and CLK90 are XOR-gated and the second intermediate clocks CLK45 and CLK135 are XOR-gated and then two results of the XOR-gating are XOR-gated with each other to generate an output clock in operation S123. The output clock is output as a pixel clock PIXEL CLK for a 10-bit color depth in operation S124.

FIG. 10C is a flowchart illustrating a method of generating an output clock of a 12-bit color depth block according to an embodiment of the inventive concept. Referring to FIG. 10C, the 12-bit color depth block receives a first intermediate clock 5× TMDS CLK and divides the frequency of the first intermediate clock 5× TMDS CLK by 3 in operation S125 and detects two second intermediate clocks CLK0 and CLK90 having a 90-degree phase difference using first and second dividers in operation S126. At this time, flip-flops may be used to synchronize the phase difference with the first intermediate clock 5× TMDS CLK. The second intermediate clocks CLK0 and CLK90 are XOR-gated with each other to generate the output clock in operation S127. The output clock is output as a pixel clock PIXEL CLK for a 12-bit color depth in operation S128.

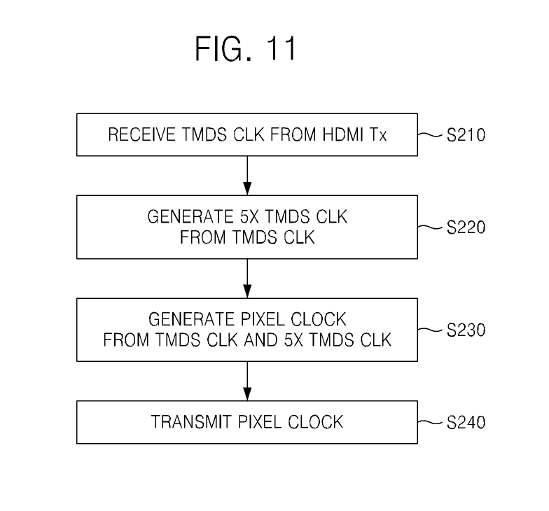

FIG. 11 is a flowchart illustrating a clock generation method in a multimedia sink according to an embodiment of the inventive concept. Referring to FIG. 11, the multimedia sink receives a transmission clock TMDS CLK from a multimedia source in operation S210 and generates a first intermediate clock 5× TMDS CLK from the transmission clock TMDS CLK using a multi-phase unit in operation S220. A pixel clock PIXEL CLK corresponding to a wanted color depth is generated from the first intermediate clock 5× TMDS CLK and the transmission clock TMDS CLK in operation S230. A clock generator of the multimedia sink transmits the first intermediate clock 5× TMDS CLK and the pixel clock PIXEL CLK to a video processor of the multimedia sink in operation S240.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, a clock generator of a multimedia system generates a first intermediate clock with multiple phases from an input clock, generates a plurality of second intermediate clocks having sequentially a predetermined phase difference from the first intermediate clock, and XOR-gates or divides the second intermediate clocks to generate a pixel clock. Accordingly, the number of PLLs or DLLs needed for clock generation is reduced. As a result, the area and the power consumption of the multimedia system are reduced or prevented from increasing.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A clock generation method in a multimedia system, the method comprising :
generating a first intermediate clock with multiple phases by multiplying a frequency of an input clock by a predetermined factor using a phase-locked loop or a delay-locked loop;
generating a transmission clock by dividing a frequency of the first intermediate clock by a predetermined number of 2 or greater than 2; and
generating a pixel clock used in the multimedia system using a frequency of the transmission clock.

2. The clock generation method of claim 1, wherein:
the predetermined number is 5; and
the generating the pixel clock comprises:
generating a plurality of second intermediate clocks having a predetermined phase difference from with each other by dividing the first intermediate clock;
generating an output clock by XOR-gating the second intermediate clocks with each other; and
generating the pixel clock by dividing the output clock.

3. The clock generation method of claim 2, wherein:
the generating the pixel clock by dividing the output clock comprises generating the pixel clock for a 10-bit color depth; and
the generating the pixel clock for the 10-bit color depth comprises:
dividing the first intermediate clock by 5;
generating four second intermediate clocks sequentially having a 45-degree phase difference from each other from a ⅕-frequency divided clock;
generating the output clock by XOR-gating the four second intermediate clocks; and
generating the pixel clock by dividing the output clock by 5.

4. The clock generation method of claim 3, wherein the generating the four second intermediate clocks sequentially having the 45-degree phase difference comprises making the number of multiple phases a multiple of 8.

5. The clock generation method of claim 3, wherein the generating the four second intermediate clocks sequentially having the 45-degree phase difference comprises sequentially adjusting reset times by synchronizing each of the reset times with a phase of a unit clock of a ⅕ divider circuit for generating the four second intermediate clocks.

6. The clock generation method of claim 2, wherein:
the generating the pixel clock by dividing the output clock comprises generating the pixel clock for a 12-bit color depth; and
the generating the pixel clock for the 12-bit color depth comprises:
dividing the first intermediate clock by 3;
generating two second intermediate clocks having a 90-degree phase difference from each other from a ⅓-frequency divided clock;
generating the output clock by XOR-gating the two second intermediate clocks; and
generating the pixel clock by dividing the output clock by 5.

7. The clock generation method of claim 6, wherein the generating the two second intermediate clocks having the 90-degree phase difference comprises making the number of multiple phases a multiple of 4.

8. The clock generation method of claim 6, wherein the generating the two second intermediate clocks having the 90-degree phase difference comprises sequentially adjusting reset times by synchronizing each of the reset times with a phase of a unit clock of a ⅓ divider circuit for generating the two second intermediate clocks.

9. The clock generation method of claim 2, further comprising:
generating the pixel clock by selecting a generation circuit that generates the pixel clock corresponding to a color depth of the multimedia system.

10. A clock generator comprising:
a transmission clock generator including a multi-phase unit configured to generate a first intermediate clock with multiple phases by multiplying a frequency of an input clock by a predetermined factor using a phase-locked loop or a delay-locked loop and a divider configured to generate a transmission clock by dividing a frequency of the first intermediate clock by 5; and
a pixel clock generator including a color depth block configured to generate an output clock from the first intermediate clock according to a 10- or 12-bit color depth, a divider configured to divide the output clock of the color depth block; and a selector configured to select either the output clock of the color depth block or a pixel clock generated from the transmission clock for an 8-bit or a 16-bit color depth and to output the selected clock as a pixel clock used in a multimedia system.

11. The clock generator of claim 10, wherein the color depth block comprises:
a divider configured to generate from the first intermediate clock a plurality of second intermediate clocks sequentially having a predetermined phase difference from each other;
an XOR logic unit configured to XOR-gate the second intermediate clocks with each other to generate the output clock; and
a divider configured to divide the output clock.

12. The clock generator of claim 10, wherein:
the color depth block comprises:
a first divider configured to divide a frequency of a first-phase first intermediate clock by 5 to generate a first second intermediate clock;
a second divider configured to divide a frequency of a second-phase first intermediate clock by 5 to generate a second second intermediate clock;
a third divider configured to divide a frequency of a third-phase first intermediate clock by 5 to generate a third second intermediate clock;
a fourth divider configured to divide a frequency of a fourth-phase first intermediate clock by 5 to generate a fourth second intermediate clock;
a first XOR gate configured to XOR-gate the first second intermediate clock and the third second intermediate clock to generate a first output signal;
a second XOR gate configured to XOR-gate the second second intermediate clock and the fourth second intermediate clock to generate a second output signal; and
a third XOR gate configured to XOR-gate the first output signal and the second output signal of the second XOR gate to generate the output clock of the color depth block for the 10-bit color depth, and
4 of the first intermediate clocks have a 45-degree phase difference from each other, and 4 of the second intermediate clocks have a 45-degree phase difference from each other.

13. The clock generator of claim 12, wherein the color depth block further comprises flip-flops configured to sequentially adjust reset times of the first through fourth dividers by respectively synchronizing the reset times with multiple phases of unit clocks of the respective first through fourth dividers.

14. The clock generator of claim 10, wherein:
the color depth block comprises:
a first divider configured to divide a frequency of a first-phase first intermediate clock by 3 to generate a first second intermediate clock;
a second divider configured to divide a frequency of a second-phase first intermediate clock by 3 to generate a second intermediate clock; and
a first XOR gate configured to XOR-gate the first second intermediate clock and the second intermediate clock to generate the output clock of the color depth block for the 12-bit color depth, and
2 of the first intermediate clocks have a 90-degree phase difference from each other and 2 of the second intermediate clocks have a 90-degree phase difference from each other.

15. The clock generator of claim 14, wherein the color depth block further comprises flip-flops configured to sequentially adjust reset times of the first and second dividers by respectively synchronizing the reset times with multiple phases of unit clocks of the respective first and second dividers.

16. A clock generator usable with a multimedia system, comprising:
a transmission clock generator configured to generate a transmission clock and a first intermediate clock with multiple phases from a reference clock using a single phase-locked loop or a single delay-locked loop; and
a pixel clock generator configured to generate a plurality of second intermediate clocks using the transmission clock and the first intermediate clock to correspond to a number of color depths, and to select at least one of the generated plurality of pixel clocks according to a selection of the color depths to output the selected one as a pixel clock.

17. The clock generator of claim 16, wherein:
the multimedia system comprises a multimedia source including the clock generator and a video processor; and
the video processor to process video data according to the pixel clock and to generate the processed video data as parallel data and the pixel clock received from the clock generator.

18. The clock generator of claim 17, wherein:
the multimedia source includes an HDMI transmitter; and
the HDMI transmitter outputs TDMA data as serial data according the received parallel data and outputs the transmission clock received from the clock generator.

19. The clock generator of claim 16, wherein:
the multimedia system comprises a multimedia source and a multimedia sink;
the multimedia source includes the clock generator, a video processor to process video data according to the pixel clock, and an HDMI transmitter to output the processed video data as TDMS data and the transmission clock received from the clock generator; and
the multimedia sink includes an HDMI receiver to receive the TDMS data and the transmission clock, a second clock generator to generate a second pixel clock according to the received transmission clock using a second single phase-locked loop or a second single delay-locked loop, and a second video processor to process the TDMS data according to the second pixel clock of the second clock generator.

20. The clock generator of claim 16, wherein the transmission clock generator comprises a multi-phase unit having the single phase-locked loop or the single delay-locked loop to receive the reference clock and to generate the transmission clock with a transmission frequency and a divider to divide the transmission clock and to generate the first intermediate clock with a first intermediate frequency higher than the transmission frequency of the transmission clock.

21. The clock generator of claim 16, wherein the pixel generator comprises a multi-clock generating unit to generate the plurality of second intermediate clocks using the transmission clock and the first intermediate clock, and a selector to select the one of the plurality of second intermediate clocks as the pixel clock.

22. The clock generator of claim 21, wherein the multi-clock generating unit comprises a plurality of color depth blocks and a plurality of dividers to output the second intermediate clocks.

23. The clock generator of claim 21, wherein the multi-clock generating unit outputs a first base clock and a second base clock of the plurality of second intermediate clocks using the transmission clock, and outputs one or more intermediate clocks of the plurality of second intermediate clocks between the first base clock and the second base clock using the first intermediate clock.

24. The clock generator of claim 23, wherein the multi-clock generating unit comprises one or more color depth clocks to output one or more color depth bit clocks using the first intermediate clock and one or more divider to divide the corresponding color depth bit clocks to generate the plurality of intermediate clocks of the plurality of second intermediate clocks.

25. The clock generator of claim 16, wherein the first intermediate clock has a first number of multiple phases, and the second intermediate clocks have different numbers of multiple phases.
